(19) United States
(12) Patent Application Publication
(10) Pub. No.: US 2019/0155972 A1
(43) Pub. Date: May 23, 2019

(54) METHOD FOR PREDICTING THE BEHAVIOUR OF A PRODUCT WITH RESPECT TO FAILURES THEREOF

(71) Applicant: Schneider Electric Industries SAS, Rueil Malmaison (FR)

(72) Inventors: Marcel CHEVALIER, Meylan (FR); Veronique BOUTIN, Le Sappey en Chartreuse (FR); Michel CERCUEIL, Claix (FR)

(73) Assignee: Schneider Electric Industries SAS, Rueil Malmaison (FR)

(21) Appl. No.: 16/179,225

(22) Filed: Nov. 2, 2018

(30) Foreign Application Priority Data
Nov. 23, 2017 (FR) 1761110

(51) Int. Cl. G06F 17/50; G06N 7/00

(52) U.S. Cl. CPC G06F 17/5009; G06F 2217/76; G06N 7/00

(57) ABSTRACT

A method for predicting the probability of technical faults in a product composed of multiple separate parts, each having its own specific life cycle and degradation kinetics, by analysing the contribution of each mode of degradation of each part to each observed fault mode of the product.

### TECHNICAL FIELD

The invention lies in the field of the prediction of the behaviour of appliances over time in relation to their potential faults.

More precisely, the invention relates to a method for predicting the probability of technical failures of a product composed of multiple separate parts, each having its own specific life cycle and degradation kinetics.

The invention also relates to a computer program stored on a recording medium comprising instructions for carrying out the steps of the method. The invention applies more particularly, but not exclusively, to the analysis of electrotechnical products but also to chemical, food or biological products composed of multiple separate parts, each having its own specific life cycle and degradation kinetics.

The invention also relates to an application of the method to determine a nominal lifetime for a circuit breaker.

### PRIOR ART

Numerous procedures are available for dealing with estimating the health of products, but the said procedures are founded either exclusively on physical characteristics (Wöhler curve, material strength approach), or exclusively on mathematical models (failure rates). Therefore, no synergy exists between the technicians who oversee the products and their failure modes, and those who design the statistical models to carry out the prediction of the behaviour of appliances over time in relation to their potential faults. However, the physical approach is relevant for certain degradation modes, but cannot afford an overall view of the system whilst the purely mathematical approach often leads to models that are too general to take account of the deep structure of the analysed products.

An aim of the invention is to alleviate the above-described drawbacks of the prior art, by making it possible to take into account the conditions of usage and environmental conditions in the statistical models of ageing of the products, and consequently in their modes and probability of failure.

### DISCLOSURE OF THE INVENTION

The aim of the invention is achieved by means of a method for predicting the probability of technical failures of a product P composed of multiple separate parts, each having its own specific life cycle and degradation kinetics, characterized by the following steps:
cataloguing the various possible failure modes of the product,
determining the possible degradation modes for each part of the product under the conditions of use that are liable to contribute to each catalogued failure mode of the said product,
determining the kinetics of degradation of each part of the product, as a function of the conditions of usage and environmental conditions for each degradation mode of each sub-assembly,
identifying the possible effects of each of the degradation modes determined on the failure modes of the product P,
evaluating the evolution law for the rate of occurrence of each catalogued failure mode for each of the identified degradation modes,
estimating the value of the failure rate as a function of the environmental conditions and of the degradation level for each of the failure modes of the product, for example on the basis of experimental or operational measurements, or of data available in the specialist literature.

The method according to the invention makes it possible to evaluate a target lifetime under the environmental conditions and conditions of use of the said product on the basis of the kinetics of each degradation mode of each sub-assembly.

The method according to the invention furthermore comprises a step consisting in determining, for each degradation mode, a rate of contribution to each failure mode of the product on the basis of the degradation kinetics determined, together with the failure rates associated with the catalogued failure modes of the product.

The method according to the invention furthermore comprises a step consisting in determining levels or a rate of degradation, together with the failure rates associated with the catalogued failure modes of the product under the environmental conditions and conditions of use of the said product, on the basis of the kinetics of each degradation mode of each sub-assembly.

The method according to the invention is implemented by a device comprising:
a first unit intended to catalogue the various possible failure modes of the product,
a second unit intended to list the possible degradation modes for each part of the product under the conditions of use that are liable to contribute to each catalogued failure mode of the said product,
a third calculation unit intended to quantify the possible effects of each degradation mode determined on the failure modes of the product, to calculate the rate of occurrence of each catalogued failure mode, for each of the degradation modes determined, to estimate the value of the failure rate for each of the failure modes of the product under actual environmental conditions and conditions of use on the basis of measurements, and to deduce the value of the rate of contribution of each degradation mode to each failure mode of the product P as a function of the occurrence rates measured for each of the degradation modes,
a fourth calculation unit intended to determine the degradation rate as a function of the kinetic degradation law, for each degradation mode of each sub-assembly.

The method and the device according to the invention make it possible to carry out fine prediction of the behaviour of appliances over time in relation to their potential faults, on the basis of actual measurements of the conditions of usage and environmental conditions of an appliance or of a product to be analysed, and of physical and mathematical models designed as a function of these actual measurements.

The invention also relates to an application of the method to determine levels or a rate of degradation, together with the failure rates associated with the catalogued failure modes of a circuit breaker composed of a Trip, of a Mechanism part, and of an Auxiliaries part.

The invention also relates to an application of the method to determine levels or a rate of degradation, together with the failure rates associated with the catalogued failure modes of a chemical product.

The invention also relates to an application of the method to determine levels or a rate of degradation, together with the failure rates associated with the catalogued failure modes of a biological product.

The invention also relates to an application of the method according to the invention to determine levels or a rate of degradation, together with the failure rates associated with the catalogued failure modes of a food product.

### BRIEF DESCRIPTION OF THE DRAWINGS

Other characteristics and advantages of the invention will emerge from the description which follows, taken by way of nonlimiting example, with reference to the appended FIGURES in which:

FIG. 1 is a flowchart schematically representing the steps of the method according to the invention in a particular exemplary application.

### DETAILED DISCLOSURE OF PARTICULAR EMBODIMENTS

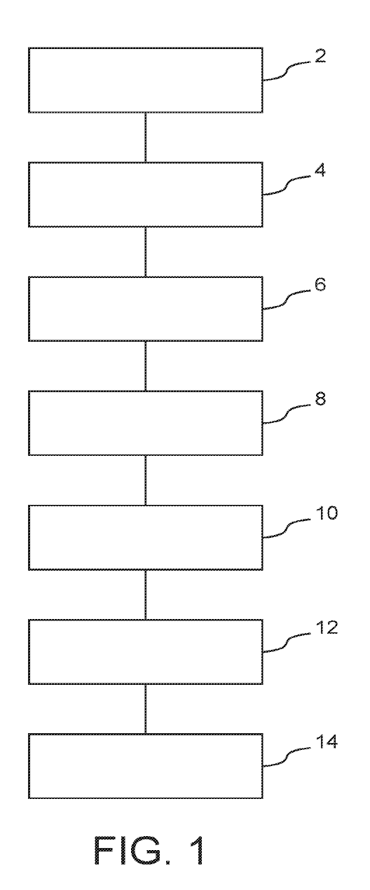

The invention will be described by reference to FIG. 1 in a particular application aimed at defining a model for predicting the technical failures of a circuit breaker.

For this purpose, during a first, so-called decomposition, phase 2, the circuit breaker is decomposed into three separate sub-assemblies consisting of a Trip A1, a Mechanism part A2, and an Auxiliaries part A3.

A second phase 4 consists in determining the possible degradation modes for each sub-assembly of the circuit breaker. In the course of this second phase 4, technicians perform actual tests so as to describe the possible degradation modes, according to the level of the environmental constraints (temperature, humidity, corrosive gases, etc.) and usage constraints (frequency of operations, value of overvoltages, etc.). Thus, for the “Mechanism” sub-assembly of the circuit breaker, a degradation of “corrosion” type, another of “wear” type, and a third of “ageing of the greases” type are for example defined. The results of the trials, combined with opinions of experts and bibliographic studies when necessary, make it possible to quantify the level of these various degradation modes per sub-assembly.

Thereafter, a third phase 6 consists in identifying, for each of the catalogued degradation modes, the ultimate action on the failure modes of the circuit breaker.

For example, for the “wear” degradation mode of the “Mechanism” sub-assembly of the circuit breaker, it is estimated that in 40% of cases the final effect will be does not open when invoked, for 30% a failure when closing, and for 30% an electrical energy continuity problem. The table hereinbelow illustrates this situation.

| | | | | Electrical |
|---|---|---|---|---|
| | | | Failure | energy |
| Failure | | Does not open | when | continuity |
| modes | | when invoked | closing | problem |
| Sub- | Degradation | | | |
| assembly | modes | | | |
| | Wear | 40% | 30% | 30% |
| Mechanism | Corrosion | | | |
| | Ageing of the | | | |
| | greases | | | |

A fourth phase 8 of so-called quantification of the failure rates consists in estimating, for each of the degradation modes of the parts of the circuit breaker, the associated value of the failure rate, under the observed environmental and usage conditions.

A fifth phase 10 consists in determining the degradation kinetics for each degradation mode of each sub-assembly.

If the conditions under which the circuit breaker operates evolve, then the kinetics of each degradation mode of each sub-assembly will provide the percentage of “nominal lifetime” consumed, with the corresponding impact on its contribution to the failure rates of the appliance via the calculations explained hereinabove.

By way of example, if, for the “Ageing of the greases” degradation mode of the “Mechanism” sub-assembly of the circuit breaker, the maker indicates a lifetime of 20 years under so-called “standard” conditions, and that it is temperature and humidity which have been identified as predominant ageing factors in this case, then the degradation kinetics will be dependent on these variables. For example, if the ambient temperature is continuously 20° above the so-called reference temperature, then it may be calculated that after 10 years, 73% of the forecast lifetime will have been consumed.

1. A method for predicting the behaviour of a product,
composed of multiple separate parts, each having its own specific life cycle and degradation kinetics, with respect to potential failures thereof, comprising:
cataloguing the various possible failure modes of the product,
determining the possible degradation modes for each part of the product under the conditions of use that are liable to contribute to each catalogued failure mode of said product,
determining the kinetics of degradation of each part of the product, as a function of the conditions of usage and environmental conditions for each degradation mode of each sub-assembly,
identifying the possible effects of each of the degradation modes determined on the failure modes of the product,
quantifying, with a calculation unit, the possible effects of each of the degradation modes determined on the failure modes of the product, calculating, with the calculation unit, the rate of occurrence of each catalogued failure mode, for each of the degradation modes determined, and evaluating the evolution law for the rate of occurrence of each catalogued failure mode, for the possible effects identified in previous step and for each of the degradation modes determined,
estimating, with said calculation unit, the value of the failure rate as a function of the environmental conditions and of the degradation level for each of the failure modes of the product.

2. The method according to claim 1, comprising a step consisting in determining, for each degradation mode, a rate of contribution to each failure mode of the product on the basis of the degradation kinetics determined, together with the failure rates associated with the catalogued failure modes of the product.

3. The method according to claim 1, comprising a step consisting in determining levels or a rate of degradation, together with the failure rates associated with the catalogued failure modes of the product under the environmental conditions and conditions of use of the said product, on the basis of the kinetics of each degradation mode of each sub-assembly.

4. The method according to claim 1 to determine levels or a rate of degradation, together with the failure rates associated with the catalogued failure modes of a circuit breaker composed of a Trip, of a Mechanism part, and of an Auxiliaries part.

5. The method according to claim 1 to determine levels or a rate of degradation, together with the failure rates associated with the catalogued failure modes of a chemical product.

6. The method according to claim 1 to determine levels or a rate of degradation, together with the failure rates associated with the catalogued failure modes of a biological product.

7. The method according to claim 1 to determine levels or a rate of degradation, together with the failure rates associated with the catalogued failure modes of a food product.

8. A computer program stored on a recording medium, comprising instructions for carrying out the steps of the method according to claim 1, when it is executed by a computer.

9. A device for evaluating a target lifetime under the environmental conditions and conditions of use of said product on the basis of the kinetics of each degradation mode of each sub-assembly, comprising:
a first unit intended to catalogue the various possible failure modes of the product,
a second unit intended to list the possible degradation modes for each part of the product under the conditions of use that are liable to contribute to each catalogued failure mode of said product,
a third calculation unit intended to quantify the possible effects of each degradation mode determined on the failure modes of the product, to calculate the rate of occurrence of each catalogued failure mode, for each of the degradation modes determined, to estimate the value of the failure rate for each of the failure modes of the product under actual environmental conditions and conditions of use on the basis of measurements, and to deduce the value of the rate of contribution of each degradation mode to each failure mode of the product P as a function of the occurrence rates measured for each of the degradation modes,
a fourth calculation unit intended to determine the degradation rate as a function of the kinetic degradation law, for each degradation mode of each sub-assembly.
